(19) United States
(12) Patent Application Publication
(10) Pub. No.: US 2021/0304628 A1
(43) Pub. Date: Sep. 30, 2021

(54) Systems and Methods for Automatic Video to Curriculum Generation

(71) Applicant: Ponddy Education Inc., San Jose, CA (US)

(72) Inventors: Franz Chen, San Jose, CA (US); Ming-Lung Chen, Fremont, CA (US); George Yang, Sunnyvale, CA (US); Ke-Chih Ning, New Taipei City (TW); Chen-Wen Chung, Taipei (TW)

(21) Appl. No.: 16/831,397

(22) Filed: Mar. 26, 2020

(51) Int. Cl. G09B 5/06; G10L 21/0208; G10L 15/26; G11B 27/19; G11B 27/031; G09B 19/06

(52) U.S. Cl. CPC G09B 5/065; G10L 21/0208; G10L 15/265; G06N 3/0454; G11B 27/031; G09B 19/06; G11B 27/19

(57) ABSTRACT

Systems and methods for automatically creating foreign language learning curricula are presented. When an input videos is received, the audio track is denoised, and then segmented according to the sentences voiced in the audio track. The sentences are transcribed and the words of the transcriptions are scored. Based on the aggregated scores, the video is deemed to be a positive or negative example for foreign language learning. The video and the transcripts of the sentence are made into instructional materials. Words in the transcripts can be tagged to indicate words that a learner of another native tongue might tend to make.

### BACKGROUND

### Field of the Invention

The invention is in the field of foreign language instruction and more particularly directed to creating custom instructional curricula from uploaded videos.

### Related Art

Video recordings (video files that include an audio channel or track) have become a significant part of modern life due to the advance of multimedia technologies. Millions of video recordings are produced every day for various purposes, both commercial and personal. Some of these videos are expressly made as instructional aids for foreign language learning, while others are later repurposed for this task. Commonly, it usually takes a month or two to develop a new curriculum for language learning.

Non-native Chinese speakers that learn to speak Chinese by watching videos of others speaking Chinese tend to make several types of pronunciation mistakes. One type are the pronunciation mistakes due to the pronunciation behaviors of the learner's native languages. People learning Chinese who are native English speakers will tend to make the same kinds of pronunciation mistakes, but a different set of mistakes than those who are native French speakers. Other mistakes are copied from the speakers in the videos themselves. For instance, those learning Chinese sometimes utilize videos of non-native Chinese speakers speaking Chinese. In this case, the learner may end up making the pronunciation mistakes of the non-native Chinese speaker in the video. The same can be true if the speaker in the video is a native speaker of Chinese, but speaks the language with poor enunciation skills.

### SUMMARY

The present invention provides systems and methods for creating educational curricula from video files such as user-provided videos. These systems and methods, among other things, identify common pronunciation errors, highlight mispronunciations made by the speaker in the video, and mark words in a transcription of the human speech component of the audio portion of the video where the user is likely to mispronounce those words. These systems and methods employ machine learning to improve at one or more of the functions described herein by learning from the users' inputs.

Sentences, by their nature, are the most common speaking or listening learning unit for spoken language, thus the present invention segments video files into smaller pieces automatically according to identified sentence boundaries. The present invention further includes automatically transcribing the speech identified in the audio tracks of videos to obtain corresponding transcriptions. The present invention can further comprise determining a learning value of a video file, and/or automatically identifying language-based pronunciation error patterns. Moreover, the present invention can comprise building a curriculum by automatically generating additional learning materials related to the video's transcriptions.

The present invention allows a variety of videos, such as those made for other purposes, to be automatically converted into instructional materials for language learning. Using these instructional materials, students can learn by listening to the speech in the audio track of the video as well as by practicing speaking, using the video as a reference. The automatic conversion from videos to good quality learnable lessons (i.e. a curriculum) improves and speeds the curriculum generation process tremendously. Common error patterns for those learners coming from another native language are, therefore, incorporated for more effective learning. Accordingly, the present invention allows curricula to be personalized according to the user's native language by identifying where the user is likely to make pronunciation mistakes, based on their native language, and to mark those places on the video transcription derived from the video.

Various embodiments of the video-to-curriculum systems and methods disclosed herein can also identify and mark pronunciation mistakes made by the speakers in the input video in order to prevent the user from being misled by these mispronunciations. The number and type of pronunciation mistakes by speakers in videos can also be used to determine the value of a video as part of a curriculum. It should be noted that while good pronunciation by a speaker in a video can be a positive learning example, poor pronunciation can also serve as a learning example of what mistakes to avoid. Additionally, where machine learning is employed in the present invention, models thereof can be continuously trained and refined through continued use.

In a typical application of the present invention, a teacher picks an arbitrary video, for instance, a video found online. The system automatically transcribes the input video and takes the transcriptions as corpus. The system generates a temporary curriculum based on the input video. The teacher can still arrange or rewrite the materials if needed. After the final curriculum has been generated, course-related materials and exercises based on the content of the curriculum are automatically attached to this curriculum. The system also automatically detects the grammar points of the sentences, labels pinyins and language proficiency levels for all words, annotates corresponding video/audio clips to the sentences, and integrate all essential elements to build a curriculum. Producing a curriculum takes the teacher only a few minutes and the content can be changed easily. Additionally, all standards of language proficiency are stored in a database and can be automatically matched to content.

### BRIEF DESCRIPTION OF DRAWINGS

FIG. 1 serves to illustrate both an exemplary method for automatically converting video files into educational curricula for foreign language instruction, as well as systems for performing these methods, according to various embodiments of the present invention.

FIG. 2 is a schematic representation of a method for segmenting video at human speech sentence boundaries according to various embodiments of the present invention.

FIG. 3 illustrates the use of an automatic speech recognition model according to various embodiments of the present invention.

FIG. 4 is a schematic representation of an exemplary method for determining whether a video provides a positive or a negative example for language instruction, according to various embodiments of the present invention.

FIG. 5 provides two examples of the use of a grammar detection model according to various embodiments of the present invention.

FIGS. 6 and 7 schematically illustrate an exemplary process for produce a language learning curriculum according to various embodiments of the present invention.

### DETAILED DESCRIPTION OF THE INVENTION

The present invention is directed to systems and methods for automatically generating language-learning curricula from ordinary video files produced for other reasons, both personal and commercial. An exemplary curriculum comprises the original video with noise removed from the audio track, a transcript of the words spoken in the video, and information that can be accessed related to the speech in the video, such as pronunciation mistakes, helpful suggestions, and so forth.

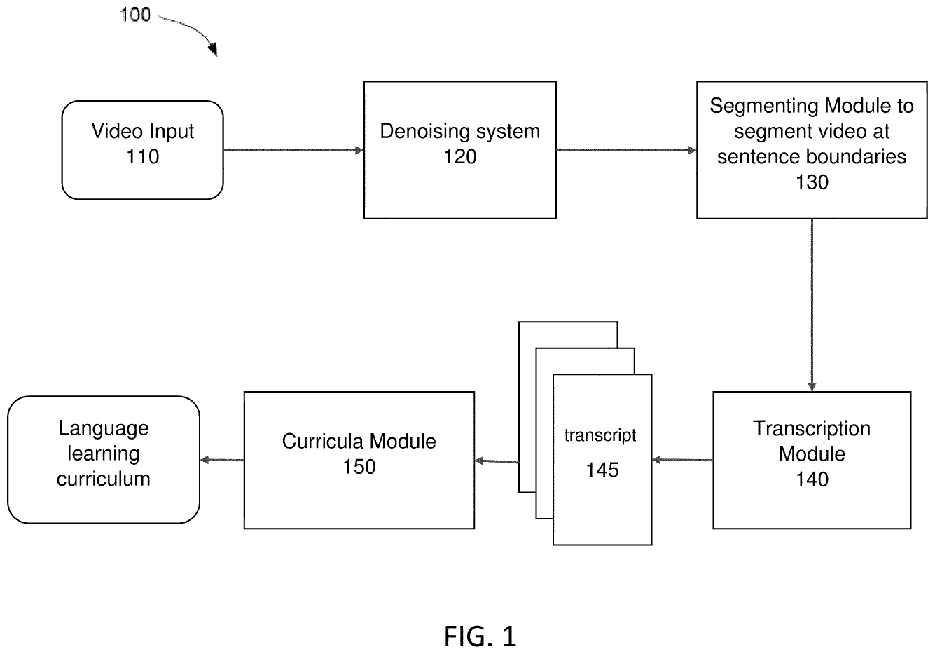

FIG. 1 is a schematic representation of an exemplary system 100 that also can be used to represent a method for automatically converting an input video file into an educational curriculum for foreign language instruction. The system 100 can be hosted on a host computing system such as a server, for example, and can communicate with multiple client devices over a network such as the Internet. Suitable client devices include personal computers and smartphones including a display and a microphone and running a client application. The client application provides an interface for a user to upload a video to be converted to a curriculum. The backend of the host system receives the video, creates the curriculum and returns, for the app or a browser to display to the user, an interactive curriculum page. In the interactive curriculum, a transcription is displayed of each spoken sentence that was identified in the video, and easily mispronounced words are labeled in displayed transcription. Additionally, the interactive curriculum provides means to allow the user to select between playing the segmented original audio (from the video) of the sentence, or practicing the current sentence or word. When the user opts to practice a word or sentence, a microphone of the client device can optionally pick up the sound of the user speaking and provide the audio to a speech scoring system. An exemplary speech scoring system is disclosed in U.S. patent application Ser. No. 16/542,760 filed on Aug. 16, 2019 and entitled “Systems and Methods for Comprehensive Chinese Speech Scoring and Diagnosis,” which is incorporated herein by reference. The speech scoring system can evaluate the quality of the user's enunciation and send feedback to user.

Both the host and client device of the system 100 includes a processor and non-transitory memory storing computer-readable instructions that when executed by the processor cause host and the client device to perform the steps of the methods disclosed herein. An exemplary method that can be performed by the host, such as a server, comprises a step of receiving an input video file 110 having an audio track, a step of removing noise from the audio track using a denoising system 120, a step of segmenting the input video according to human speech sentence boundaries using a segmenting module 130, a step of transcribing the spoken sentences identified within the cleaned audio track using a transcription module 140 to create sentence transcripts 145, and a step of generating learning materials from the transcriptions 145 using a curricula module 150.

The step of receiving an input video file can include receiving, for instance, an MPEG file, a Windows Media Video file, or a WebM file. The input video preferably includes one or more people speaking a language that the user seeks to become more proficient in. For the purposes of illustration, the present disclosure uses Chinese as the example of the language to be learned, and assumes the user has a different native language. However, the systems and methods disclosed herein can be used to generate curricula to be used to gain proficiency in any language. Input videos can be supplied by a user or can be supplied by an organization seeking to produce suitable curricula for language education. In the case of user-supplied input videos, in this step the user can upload videos from a client device (e.g., a PC, tablet, or smartphone) across a network connection to the host server to generate learning materials therefrom.

In the noise removal step, noise is removed from the audio track of the input video to produce a cleaned audio track. Noise, in the present context, is any sound other than the human speech component of the audio. Removing noise can include, in some embodiments, analyzing the track to differentiate the speech component from background sounds such as music, traffic, animal sounds, and so forth. Exemplary denoising systems suitable for performing this step can employ machine learning, such as through the use of generative adversarial networks (GANs). GAN-based speech enhancement systems are well known in the art, see, for example, “Towards Generalized Speech Enhancement with Generative Adversarial Networks” by S. Pascual et al., Cornell University, April, 2019.

In a denoising system 120 that employs machine learning, before the denoising system 120 is used in the denoising step, a denoising model of the denoising system 120 is trained with various noise data (music and so forth) as non-speech signatures. In some training embodiments, an ordinary noise model can be used to generate noises that simulate noises found in various environments. The generated noises are then added to clean speech audio files to generate training data for training the denoising model. During the denoising step, in some embodiments, the denoising system 120 identifies the non-speech signals, removes them by filtering, and amplifies the remaining speech signal to produce the cleaned audio track.

The step of segmenting the video according to human speech sentence boundaries can include, in various embodiments, taking the cleaned audio track as the input, determining the sentence boundaries (i.e. the beginning and ending times of each sentence) and using the sentence boundaries to partition the video into smaller video segments. Sentence boundary detection can also be based on machine learning, for example, through the use of neural networks techniques. During training, a sentence boundary model is trained to automatically extract useful features, such as sound volumes, durations of silences, characteristics of human voices, etc., to identify the sentence boundaries. In runtime, the trained model is used to predict the sentence boundaries in the cleaned audio track. This time-boundary information is sometimes provided in Conversation Time Marked (CTM) formatted files.

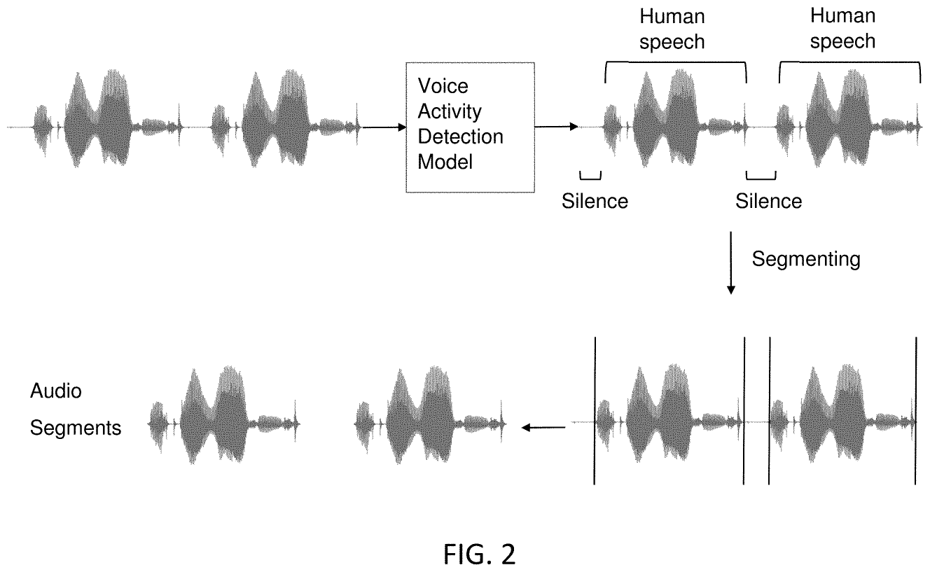

FIG. 2 illustrates an exemplary process for segmenting video according to human speech sentence boundaries. In the example, the cleaned audio track is received as the input, in this example an exchange between two people. The cleaned audio track is a digital file in a digital audio format such as .WAV. A trained voice activity detection model is used to predict those portions of the cleaned audio track that represent spoken sentences, for example, by noting the periods of silence therebetween. A voice activity detection model is also a deep learning-based model which takes clean speech audio with periods of silence as input and then outputs the time intervals of the non-silent speech part. The voice activity detection model learns how to determine whether or not sample points represent human speech according to the training corpus fed to it. Exemplary voice activity detection models include those found at https://github.com/jtkim-kaist/VAD and https://ieeexplore.ieee.org/document/8309294.

In some embodiments, the cleaned audio track is sampled at a succession of sample points, and for each sample point a prediction is made whether or not the sample point represents human speech. In these embodiments, if a series of sample points are predicted as being human speech, for a duration equal to a threshold, such as 300 ms, then the series of sample points is considered to be human speech, otherwise the sample points are considered to be silence.

The cleaned audio track can sometimes still retain some residual noise. If the cleaned audio track lacks residual noise, a sample point can be determined to represent human speech if the volume of the sample point is over threshold, otherwise it is viewed as silence. On the other hand, if the cleaned audio track still contains some residual noises, the voice activity detection model is used to determine human speech from silence.

To segment the cleaned audio track into sentences, the portions that are identified as sentences are delineated by their start and end times, each such delineated portion being an audio segment. The same start and end times are then applied to the video to create video segments synchronized to the audio segments. In some embodiments, a user can be provided with options, through the application operating on the client device, to adjust the boundary prediction results on the display of the client device.

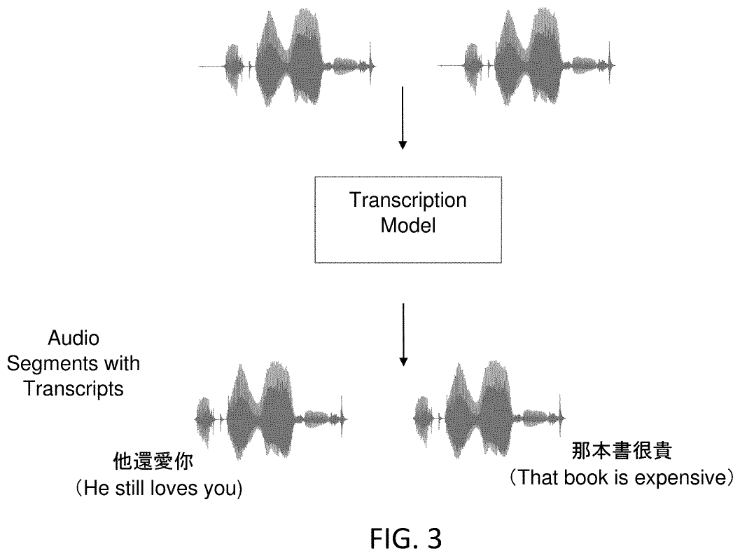

Returning to FIG. 1, the step of transcribing the audio track to create transcripts 145 takes the segmented cleaned audio track as the input, as illustrated by FIG. 3. Audio transcription can be based on machine learning and probabilistic techniques embodied in an transcription module 140 such as those disclosed in the Kaldi Speech Recognition Toolkit, https://infoscience.epfl.ch/record/192584/files/Povey_ASRU2011_2011.pdf. Another example is disclosed in US patent application publication US 2015/0058,003, the disclosure of which is incorporated by reference herein. In embodiments such as these, the transcription module 140 can include a trained machine learning model that is used to extract human speech features (e.g. mfcc features) from the cleaned audio track to determine a succession of phonemes, as illustrated in U.S. patent application Ser. No. 16/542,760. Successive phonemes can then be matched to words to render the spoken sentence as a transcript 145, namely text in the language of the speaker representing words and punctuation, for instance as Chinese characters where the speaker in the video speaks Chinese. Thus, in various embodiments, the transcription module 140 determines the language of the human speech and provides transcripts 145 using appropriate characters in the same language. In various embodiments, transcripts 145 can additionally include the sentence transliterated into another language or otherwise represented. For example, where the language is Chinese, the transcript 145 of a sentence can include both the determined Chinese characters and the pinyins that go with each word.

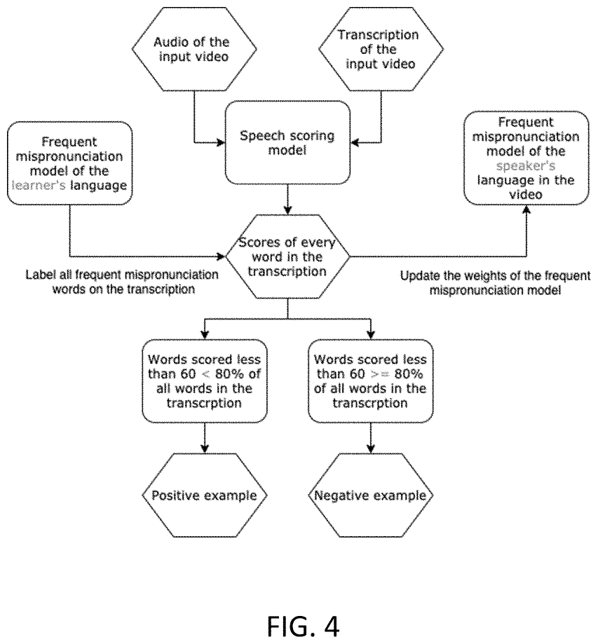

After transcripts 145 are obtained, curricula module 150 receives the transcripts 145 to generate a language learning curriculum comprising language learning materials based on the input video. The curricula module 150 determines whether the input video is a positive or a negative example in terms of its value as a curriculum. The curricula module 150 also builds a statistical model to record frequent mispronounced words according for the spoken language in the video. The curricula module 150 further automatically labels frequently mispronounced words according to learner's native language to improve learning efficiency. FIG. 4 illustrates an exemplary process that can be executed by the curricula module 150 for performing these tasks.

In FIG. 4 a forced alignment between the transcripts 145 and the cleaned audio track is performed to identify the start and end times of each word in the transcripts 145 so that the sound of each word can be isolated and used in curricula. Further, a speech scoring model is employed to score the quality of the human speech in the cleaned audio track with reference to the transcripts 145 derived therefrom. In particular, each word of each transcript 145 receives a score, for example, between 0 and 100, and those scores are used in the aggregate to determine whether the input video is a positive or a negative example. U.S. patent application Ser. No. 16/542,760 describes suitable methods for scoring audio recordings of spoken words for their pronunciations.

A model of frequently mispronounced words, in the language spoken in the video, for native speakers of the learner's language is also used to tag frequently mispronounced words when they are present in a transcript 145. In some embodiments, the corresponding statistical model is used to predict the 100 most frequent word mispronunciations and label them on the text.

To produce the initial model, in some embodiments, five Chinese sentences which include all phonemes in Chinese are given to native speakers of another language, such as Spanish, to read aloud while their voices are recorded. A speech scoring system is then used to score all the voice recordings to build an initial mispronunciation model for the combination of the target language and native tongue (e.g., Chinese as spoken by Spanish native speakers). As learning curricula are used, these models can be revised. Every time a person coming from a native language practices a target language spoken in a video, the words that are scored below a threshold are noted, and as words are found over time to be mispronounced more or less frequently than in the existing model the weightings assigned to the words are varied accordingly.

Another model of frequently mispronounced words, in the language spoken in the video, for native speakers of the same language as spoken in the video (e.g., mispronunciations of Chinese by native Chinese speakers, where the speaker in the video is a native Chinese speaker speaking in Chinese) is also employed to tag words in the transcript that were mispronounced by the speaker in the video.

Next, the scores of the words of the video are evaluated to determine whether the video constitutes a positive or a negative example. In an exemplary embodiment, both a threshold percentage of the number of words in the video and a threshold score are employed. In the example of FIG. 4, where more than 80% of the words have a score more than 60 then the video is deemed a positive example, while for sentences in which 80% or less of the words have a score more than 60 then the video is deemed a negative example. Words that are scored below the threshold, in this case 60, can be used to train the mispronunciation pattern models by updating weights assigned to the words in the mispronunciation pattern model. In some embodiments individual transcripts 145 for sentences of the video are similarly determined to be positive or negative.

Curricula module 150 can also perform one or more of word segmentation, word-level labeling, pinyin labeling, vocabulary targeting, and grammar detection. Word segmentation tokenizes characters into word sequence that makes sense in the context. For instance, in Chinese, every character has its meaning, and two or three characters can be combined to form a word which sometimes has a different meaning. Unlike written western languages where spaces denote word boundaries, written Chinese relies on the reader to infer the word boundaries from the context. When Chinese text is processed, word segmentation is applied to determine whether the characters in a sentence should be separated individually or should be combined according to the context. The process of taking all contextual clues into consideration and inferring the correct word boundaries without creating a nonsense sentence is termed word segmentation or tokenization.

Word-level labeling labels each word to various national and international standard levels. For instance, the oral proficiency levels of the ACTFL Guidelines map to the continuum of language proficiency from highly articulate to a level of little or no functional ability. Pinyin labeling labels each word with its phonetic notation. Vocabulary targeting identifies vocabulary and links words to corresponding vocabulary profile pages.

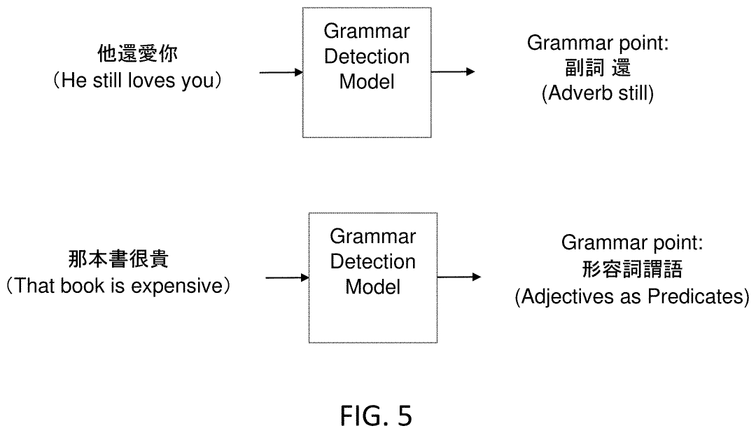

Grammar detection, illustrated by FIG. 5, analyzes the context of the sentences of the transcripts and detects the grammar points. Here, a deep learning method can be applied to achieve the grammar detection by employing a deep learning classifier that has been trained to classify the grammar points a given sentence belongs to.

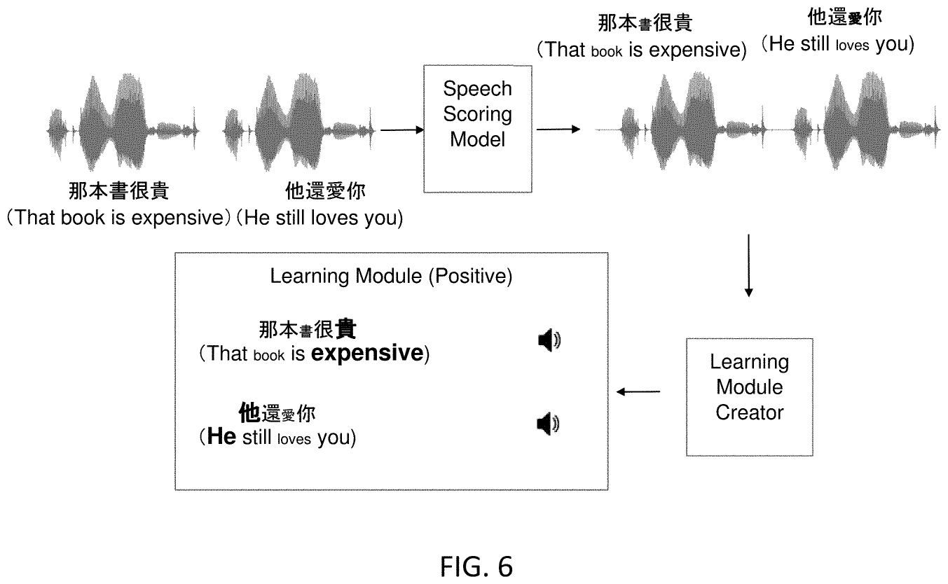

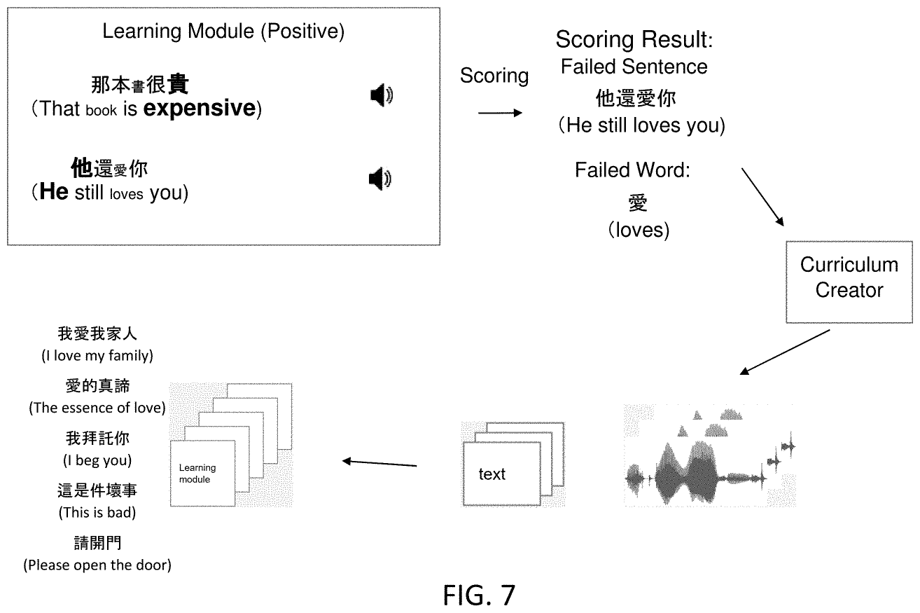

FIGS. 6 and 7 schematically illustrate an exemplary process performed by a curricula module 150 to produce a language learning curriculum. In FIG. 6, sentence transcripts 145 and their corresponding audio segments of the cleaned audio track are provided to a speech scoring model is used to score the quality of the speech in the audio segments. Words in the transcripts 145 are scored and words that score below a threshold are tagged. In the illustration of FIG. 6 these words (“book” and “loves”) are denoted by a smaller font. In educational materials produced from the transcripts 145 the words that are tagged as mispronounced can be displayed in a different color, highlighted, made to shimmer or blink, or otherwise visually differentiated from the other words of the sentence.

The tagged transcripts 145 are then provided to a learning module creator. The learning module creator produces learning modules for both positive and negative videos. A learning module is audiovisual content to be presented through a graphical user interface like a browser window or a smartphone display. Each learning module comprises one or more sentence transcripts 145 and corresponding audio segments from a video. In exemplary embodiments, the transcripts 145 are displayed on the graphical user interface with certain words visually differentiated as noted above. The graphical user interface provides the user the ability to play the audio segment corresponding to a transcript 145, for example, with a selectable audio icon.

Other tools can likewise be made available in various embodiments. Such tools can include the ability to play the video segment corresponding to the transcript 145, the ability to select a word or character to access more information thereon, or to play a recording from a library of the proper pronunciation. Another tool that can be provided by the module is an interface that allows the user to practice speaking the sentence, while the audio of the user's speech is recorded and the pronunciations of the words of the sentence are scored, and the resulting scores and detailed diagnostics on any errors are provided to the user.

Further, the module can visually differentiate words of the transcripts 145 that are commonly mispronounced by people learning the language who are native speakers of the same language of which the user is a native speaker. In FIGS. 6 and 7 these words (“expensive” and “he”) are denoted by a larger font and the use of bold, but as above, this is merely for illustrative purposes for this disclosure and such words can be differentiated by color, for example.

In FIG. 7, the learning module also can send the transcripts 145, associated video and audio segments, recordings of the user speaking the transcripts 145, and the scoring of the words and the detailed diagnostics to a curriculum creator. The curriculum creator takes this information to select other learning modules that would be relevant to helping a person correct the specifically identified pronunciation errors. More specifically, the curriculum creator takes into account both relevance in the audio domain as well as in the text domain to select other learning modules.

Relevance in the audio domain refers to words or phrases that sound similar to the target. As an example of audio domain relevance, [symbol] is pronounced as “eye” so words sharing similar pronunciations like [symbol] (b-eye), [symbol] (wh-eye), [symbol] (k-eye) have relevance and therefore learning modules that include these words could be good selections. Similarly, relevance in the text domain refers to the meaning and grammatical usage of the target word. Thus, for example, for the word “loves,” learning modules that present phrases or sentences about relationships or romance would be relevant, as would those that use the verb and noun uses of the word “loves” [symbol] .

The curriculum creator then selects a number of learning modules from a library thereof. The learning modules with the highest relevance are chosen. In the illustration of FIG. 7, the exemplary learning modules are relevant in either or both domains.

The descriptions herein are presented to enable persons skilled in the art to create and use the systems and methods described herein. Various modifications to the embodiments will be readily apparent to those skilled in the art, and the generic principles defined herein may be applied to other embodiments and applications without departing from the spirit and scope of the inventive subject matter. Moreover, in the following description, numerous details are set forth for the purpose of explanation. However, one of ordinary skill in the art will realize that the inventive subject matter might be practiced without the use of these specific details. Flowcharts in drawings are used to represent processes. A hardware processor system may be configured to perform some of these processes. Modules within flow diagrams representing computer implemented processes represent the configuration of a processor system according to computer program code to perform the acts described with reference to these modules. Thus, the inventive subject matter is not intended to be limited to the embodiments shown, but is to be accorded the widest scope consistent with the principles and features disclosed herein.

The use of the term “means” within a claim of this application is intended to invoke 112(f) only as to the limitation to which the term attaches and not to the whole claim, while the absence of the term “means” from any claim should be understood as excluding that claim from being interpreted under 112(f). As used in the claims of this application, “configured to” and “configured for” are not intended to invoke 112(f).

1. A method comprising:
receiving, with a host computing system, a video including an audio track having human speech in a target language;
denoising the audio track to create a cleaned audio track with non-speech components removed, wherein denoising the audio track includes using a generative adversarial network;
segmenting the video at sentence boundaries of the human speech by segmenting the cleaned audio track at the sentence boundaries and then segmenting the video at the same sentence boundaries;
transcribing sentences identified within the cleaned audio track to produce a transcript for each identified sentence; and
generating a language learning curriculum from the video using the transcripts.

2. The method of claim 1 wherein the computing system is a server and wherein the video is receiving from a client device.

3. (canceled)

4. The method of claim 1 wherein denoising the audio track includes training a denoising model.

5. The method of claim 4 wherein training the denoising model includes generating noises, and adding the generated noises to clean speech audio files to generate training data for training the denoising model.

6. The method of claim 1 wherein segmenting the cleaned audio track at the sentence boundaries includes using a trained voice activity detection model to predict those portions of the cleaned audio track that represent spoken sentences, thereby identifying a number of spoken sentences.

7. The method of claim 6 wherein segmenting the video at sentence boundaries further includes, for each identified spoken sentence, determining a start time and an end time on the cleaned audio track, and applying the same start and end times to the video to create video segments synchronized to the audio segments.

8. The method of claim 1 wherein transcribing spoken sentences includes using a trained machine learning model to extract human speech features from the cleaned audio track.

9. The method of claim 1 wherein the transcript is text in the language of the speaker.

10. The method of claim 1 wherein generating the language learning curriculum is performed by an artificial intelligence engine.

11. The method of claim 1 wherein generating the language learning curriculum includes determining whether the input video is a positive or a negative example for language instruction.

12. The method of claim 1 wherein generating the language learning curriculum includes a forced alignment between the transcripts and the cleaned audio track to identify the start and end times of each word in the transcripts.

13. The method of claim 1 wherein generating the language learning curriculum includes scoring each word of each of the transcripts.

14. The method of claim 1 wherein generating the language learning curriculum includes tagging words in the transcripts, where the words are frequently mispronounced by native speakers of the learner's language when speaking the target language.
